(19) United States
(12) Patent Application Publication
(10) Pub. No.: US 2016/0315777 A1
(43) Pub. Date: Oct. 27, 2016

(54) CERTIFICATE UPDATING

(71) Applicant: Citrix Systems, Inc., Fort Lauderdale, FL (US)

(72) Inventors: David Alessandro Penry LLOYD, Cambridge (GB); Christopher Morgan MAYERS, Histon (GB)

(21) Appl. No.: 14/696,101

(22) Filed: Apr. 24, 2015

(51) Int. Cl. H04L 9/32

(52) U.S. Cl. CPC H04L 9/3265

(57) ABSTRACT

Approaches described herein provide devices, methods, and mediums for building a chain of certificates. In particular, various devices can communicate with a certificate repository. The certificate repository can provide information indicating whether a certificate stored on a device is valid. If the certificate is no longer valid, then a new certificate is acquired from the certificate repository. This new certificate can have certificate extensions. These certificate extensions can be used by a device to build a chain to a root certificate authority to validate the device.

### BACKGROUND

Public Key Infrastructure (PKI) is one of the most commonly used conventions in the field of cyber-security. Indeed, since at least 1976, asymmetric key algorithms have been used to secure communications between networked devices. PM is an arrangement wherein a certificate authority produces digital certificates (or certificates) that can include public keys used to identify, authenticate, and certify users or devices.

Certificates are issued by certificate authorities, which can digitally sign and publish a public key bound to entity device, which could be a user or a computer. A certificate authority's role is generally to provide certificates to certify that a transaction is associated with such entity device. Authentication of a particular device (such as another certificate authority or end entity) typically involves a certificate private key, so trust in the particular device's key relies on trust in the certificate authority's private key.

In a PKI environment, valid certificates need to be installed and maintained on various endpoints, which can be installed at various locations. These certificates have limited validity periods and occasionally need to be updated with new information. In some instances, certificates must be updated at relatively short notice, which can be difficult depending on how a system is designed. Further, certificates identifying certificate authorities, such as root certificate authorities and intermediate certificate authorities, can have a lifecycle that is independent of an end entity's certificate. Thus, whenever an update of a certificate occurs, there needs to be a change over period so that end entities that are out of date do not experience downtime periods. Similarly, if companies or departments within companies were to merge, certificates would need to be updated quickly and in bulk such that the respective end entities (e.g., client devices such as a laptop computer or smart phone) that need new certificates are able to trust and be trusted. These changes must happen rapidly, without administrator intervention, and securely such that sensitive certificate authority communication protocols are not exposed on public facing servers.

### BRIEF DESCRIPTION OF THE DRAWINGS

Reference will now be made to the accompanying drawings showing example embodiments of this disclosure. In the drawings:

FIG. 1 is a block diagram of an exemplary network environment, consistent with embodiments of the present disclosure.

FIG. 2 is a block diagram of an exemplary PM network environment, consistent with embodiments of the present disclosure.

FIG. 3 is a block diagram of an exemplary PM network environment, consistent with embodiments of the present disclosure.

FIG. 4 is a block diagram of an exemplary certificate authority, consistent with embodiments of the present disclosure.

FIG. 5 is a block diagram illustrating an example approach for replacing a trust anchor, consistent with embodiments of the present disclosure.

FIG. 6 is a block diagram illustrating an example approach for cross-signing a trust anchor, consistent with embodiments of the present disclosure.

FIG. 7 is a flowchart representing an exemplary method of building a chain, consistent with embodiments of the present disclosure.

FIG. 8 is a flowchart representing an exemplary method of a certificate-chain maintenance evaluation, consistent with embodiments of the present disclosure.

FIGS. 9A-9B are block diagrams of exemplary computing devices, consistent with embodiments of the present disclosure.

### DETAILED DESCRIPTION

Reference will now be made in detail to the exemplary embodiments implemented according to the present disclosure, the examples of which are illustrated in the accompanying drawings. Wherever possible, the same reference numbers will be used throughout the drawings to refer to the same or like parts.

The exemplary embodiments described herein provide systems and/or methods for updating certificates using authority information access certificate extensions—a feature of Public Key Infrastructure X.509 (PKIX)—without exposing sensitive certificate authority communication protocols on public facing servers. Updating certificates in this exemplary manner allows devices that have previously been issued server/client device and trust anchor certificates to autonomously handle pushed certificates, cross-signing with new chains, and a transition between old and new certificate chains and trust anchors (also referred to herein as root certificate authorities).

In various embodiments, when certificate chains are updated, there are periods of time where certificate authorities and end entities possess an out-of-date certificate, are not using an available new certificate, and/or are working with different versions of a certificate (e.g., two certificates that identify the same device). To remove an old or otherwise incorrect certificate, an Authority Information Access extension (AIA extension) can provide a URL that can be used by a certificate authority or end entity to download more recent versions of certificate chains.

An AIA extension (e.g., id-ad-caIssuers) provides a device (e.g., a certificate authority, an end entity, etc.) that uses a certificate with information regarding how to access services relating to the certificate authority (or authorities) that issues certificates for the device. As described in RFC 5280, an AIA extension can include on-line validation services and certificate authority policy data. An AIA extension can be included in end entity or certificate authority certificates. As will be described in more detail below, a file referenced by an AIA extension can be a PKCS #7 file (e.g., a file that contains certificates issued by a certificate authority and included in the certificate authority's repository). The transport layer security (TLS) specifications in RFC 5246 typically allow a single certificate chain to be presented to a client device. Some environments, however, provide for cross-signing (e.g., where two or more chains from different certificate authorities can identify the same device). The AIA id-ad-caIssuers extension can be used to handle these situations by providing http/Idap access to an up-to-date list of all valid chains. Although, in some embodiments discussed herein, cross-signing is not used in a typical manner as suggested by PKIX designers, the PKIX specification can use an AIA extension to include various versions of issuer certificates and update trust anchor certificates.

It is appreciated that by implementing at least some embodiments as described herein, all certificates in a PKI environment can be updated by reissuing them at a third party certificate authority, and waiting for endpoints to poll for them (e.g., once a day). Further, root certificate authorities and intermediate certificate authorities can be updated using standard RFC 5280 extensions, and without the need for using Active Directory, or a similar directory service. Moreover, by using embodiments described herein, even when a TLS client device and server are using different versions of a certificate, a root certificate authority's update certificates can allow extensions to a PKIX to validate certificates correctly. As an example, if a certificate cannot be validated (e.g., because a server provides an out-of-date chain), certificates can assist in creating a valid chain to a trust anchor, which can involve running a Trust Anchor update algorithm, or building a chain to an older Trust Anchor that is still within an old-with-new validity period, as described below.

Traditionally, certificate distribution methods have been proprietary communication mechanisms, such as with Active Directory. Further, traditional certificate validation methods may not operate correctly in cases where end entities and intermediate certificate authorities are not both up-to-date with a latest certificate chain. In some embodiments described herein, AIA extensions in new certificates can be used to resolve such situations.

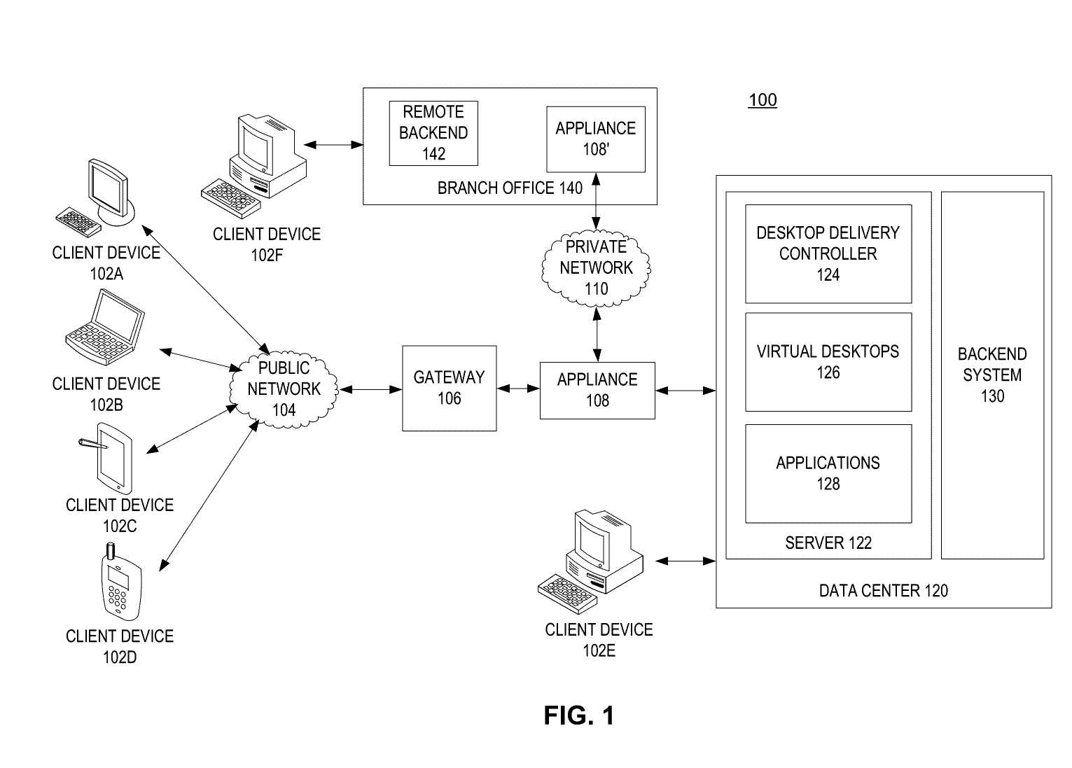

FIG. 1 is a block diagram of an exemplary network environment 100. While exemplary network environment 100 is directed to a virtual network environment, it is appreciated that network environment 100 can be any type of network that communicates using packets. Network environment 100 can include one or more client devices 102, a public network 104, a gateway 106, an appliance 108 that can (or can cause a device to) switch protocols, a private network 110, a data center 120, and a branch office 140.

One or more client devices 102 are devices that can acquire remote services from data center 120 through various means. In some embodiments, client devices are end entities. Client devices 102 can communicate with data center 120 either directly (e.g., client device 102E) or indirectly through a public network 104 (e.g., client devices 102A-D) or a private network 110 (e.g., client device 102F). While client devices 102 are portrayed as a computer (e.g., client devices 102A, 102E, and 102F), a laptop (e.g., client device 102B), a tablet (e.g., client device 102C), and a mobile smart phone (e.g., client device 102D), it is appreciated that client device 102 could be any type of device that can send and receive signals to and from data center 120, such as a wearable computer (e.g., glasses or a wristwatch).

Gateway 106 is a physical device or is software that is part of a physical device that interfaces between public network 104 and appliance 108 that can switch what type of protocol it transmits data with. Gateway 106, for example, can be a server, a router, a host, or a proxy server. In some embodiments, gateway 106 can include or be coupled to a firewall separating gateway 106 from public network 104 (e.g., Internet). Gateway 106 has the ability to modify signals received from client device 102 into signals that appliance 108 and/or data center 120 can understand and vice versa.

One or more appliances 108 can be included in environment 100. For example, appliance 108 can be an application delivery controller. An application delivery controller is a computer network device which can perform common tasks such as those done by websites to remove load from the web servers, provide load balancing, etc. In some embodiments, appliance 108 can be virtual. Appliances 108 can be located at a variety of locations. For example, appliance 108 can be located in a server, in between a server/data center and a gateway (e.g., 108), at a location connected to a device via a private network (e.g., appliance 108′), and/or in public network 104, a cloud, or other multi-tenant environment. In some embodiments, the functionality of gateway 106 and appliance 108 can be located in a single physical device, which can be an application delivery controller. It is further contemplated that such an appliance 108 can be located on client device 102 (or a proxy device such as a proxy server). In any case, one or more appliances 108 can work alone or in conjunction with one or more other appliances 108.

Data center 120 is a central repository, either physical or virtual, for the storage, management, and dissemination of data and information pertaining to a particular public or private device. Data center 120 can be used to house computer systems and associated components, such as one or more physical servers, virtual servers, and storage systems. Data center 120 can include, among other things, one or more servers (e.g., server 122) and a backend system 130. In some embodiments data center 120 can include gateway 106, appliance 108, or a combination of both.

Server 122 is an electronic device that can be represented by any electronic addressable format, and can exist as a single device or a member of a server farm. Server 122 can be a physical server or a virtual server. In some embodiments, server 122 can include a hardware layer, an operating system, and a hypervisor creating or managing one or more virtual machines. Server 122 provides one or more services to an endpoint. These services include providing one or more applications 128 to one or more endpoints (e.g., client devices 102A-F or branch office 140). For example, applications 128 can include Windows™-based applications and computing resources.

In some embodiments, the services include providing one or more virtual desktops 126 that can provide one or more applications 128. Virtual desktops 126 can include hosted shared desktops allowing multiple users to access a single shared Remote Desktop Services desktop, virtual desktop infrastructure desktops allowing each user to have their own virtual machine, streaming disk images, a local virtual machine, individual applications (e.g., one or more applications 128), or a combination thereof.

Backend system 130 is a single or multiple instances of computer networking hardware, appliances, or servers in a server farm or a bank of servers and interfaces directly or indirectly with server 122. For example, backend system 130 can include Microsoft™ Active Directory, which can provide a number of network services, including LDAP directory services, Kerberos-based authentication, domain name system (DNS) based naming and other network information, and synchronization of directory updates amongst several servers. Backend system 130 can also include, among other things, an Oracle backend server, a SQL Server backend, and/or a dynamic host configuration protocol (DHCP). Backend system 130 can provide data, services, or a combination of both to data center 120, which can then provide that information via varying forms to client devices 102 or branch office 140.

Branch office 140 is part of a local area network that is part of the WAN having data center 120. Branch office 140 can include, among other things, appliance 108′ and remote backend 142. In some embodiments, appliance 108′ can sit between branch office 140 and private network 110. As stated above, appliance 108′ can work with appliance 108, etc. Remote backend 142 can be set up in similar manner as backend system 130 of data center 120. Client device 102F can be located on-site to branch office 140 or can be located remotely from branch office 140.

Appliances 108 and 108′ and gateway 106 can be deployed as is, or executed on any type and form of computing device. Including any computer or networking device capable of communicating on any type and form of network described herein.

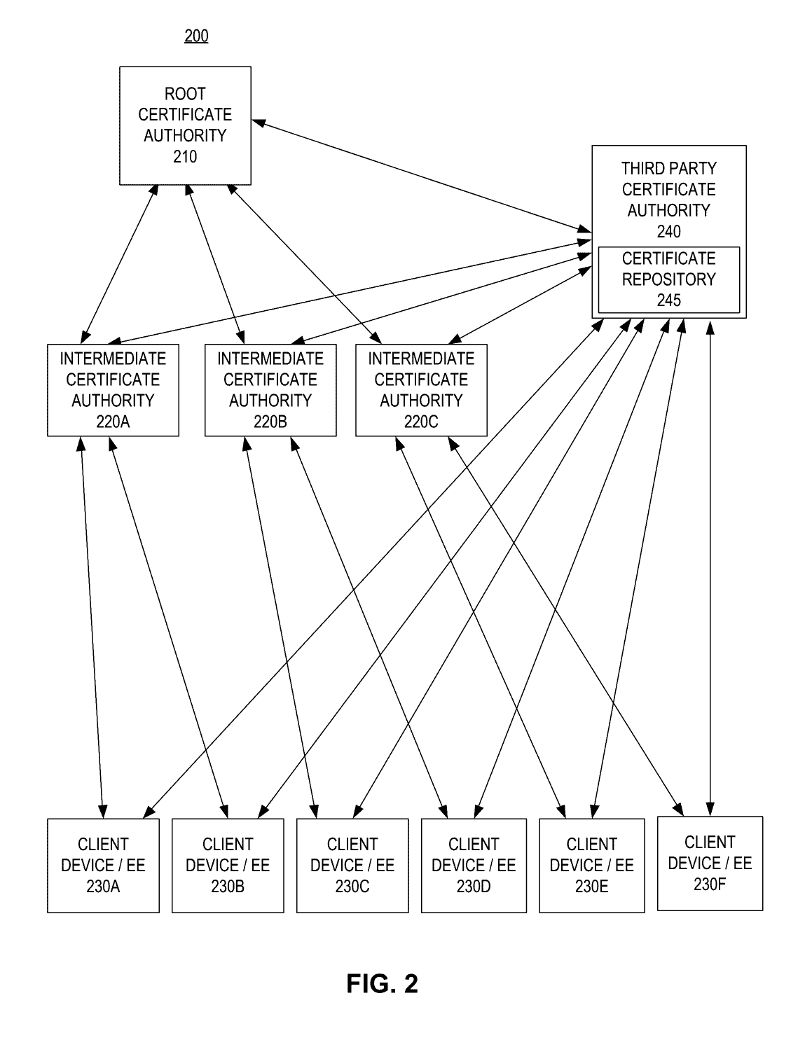

FIG. 2 illustrates a block diagram of an exemplary PKI network environment 200, consistent with embodiments of the present disclosure. Environment 200 includes a plurality of devices including a root certificate authority 210, intermediate certificate authorities 220A, 220B, and 220C (collectively 220), end entities 230A, 230B, 230C, 230D, 230E, and 230F (collectively 230), and a third party certificate authority 240 that includes a certificate repository 245. In various embodiments, certificate authorities such as third party certificate authority 240 can return all, or some of the certificates stored in certificate repository 245 to various certificate authorities and end entities, such as root certificate authority 210, one or more intermediate certificate authorities 220, and one or more end entities 230 via a PKCS #7 file.

Some of the approaches described herein illustrate the functionality of PKI network environment 200, consistent with embodiments of the present disclosure. For example, it should be appreciated that all certificate authorities (e.g., 210, 220, and 240) can maintain a repository including all of the certificates a certificate authority issues (not only 240). In some embodiments, a certificate repository (e.g., 245) can be in a location different from a certificate authority (e.g., 240). For example, a repository can be located in a separate fileshare or on a web-server HTTP cache. In any case, the a Subject Information Extension (SIA) id-ad-caRepository can point to a valid repository to keep any of the certificate authorities as described herein up to date (e.g., such that the certificate authority has a correct, up-to-date, certificate). In various embodiments, end entities 230 or intermediate certificate authorities 220 point to a repository residing on its immediate parent certificate authority. In some embodiments, intermediate certificate authority 220 can refer to its parent, using what is sometimes referred to as a cascade update process. In such a process, root certificate authority 210 can perform a root certificate update algorithm, after which an intermediate certificate authority 220 can pull an updated certificate from root certificate authority 210, after which an end entity 230 can pull an updated certificate from intermediate certificate authority 220. In embodiments described herein, if a device needs to authenticate to pull an updated certificate, it can use its existing private key.

In some embodiments, root certificate authority 210 can be in a protected network, such that the end entities 230 cannot access the root certificate authority's certificate repository directly. Thus, this process, sometimes referred to as the pull from caRepository process, can be used such that end entities can retrieve one or more certificates.

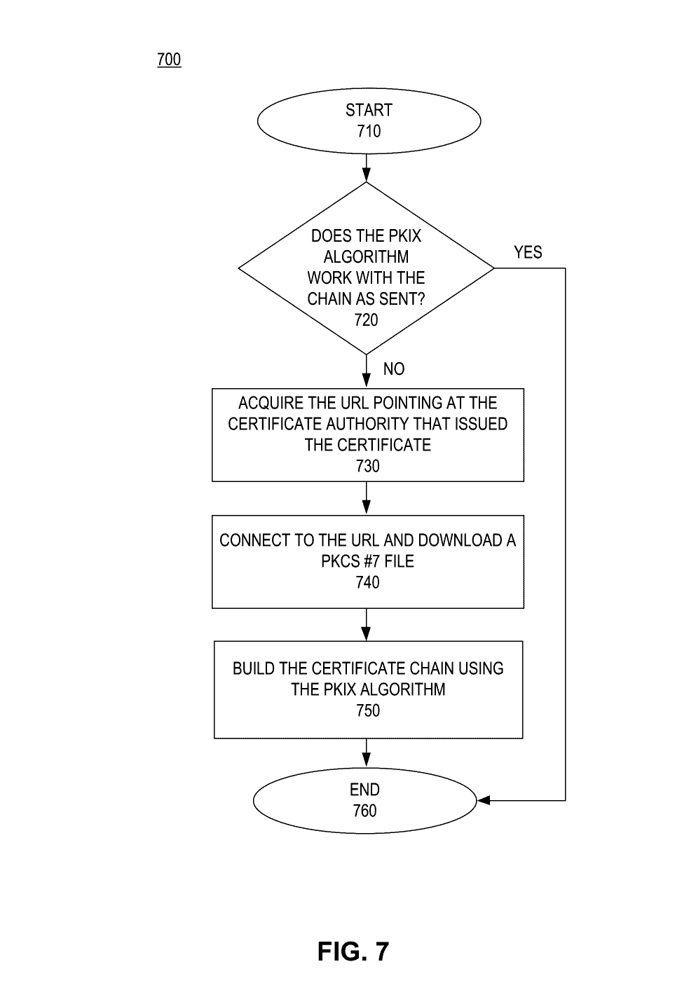

Intermediate certificate authority 220 can update its certificate, or change certificates that it has previously issued. In such embodiments, intermediate certificate authority 220 can reissue all certificates that are associated with it, and re-sign them as required. For example, a pull from certificate authority, as later described in FIG. 7, can be used to update device certificates that the intermediate certificate authority 220 issued also.

In some instances a URL accessing the remote certificate authority can be entered by an administrator and, in some instances, access can require a password to be entered by an administrator. Next, a PKCS #7 file is received containing the identity of the certificate of the device (such that the public key matches the private key), and a certificate chain validating PKIX to the root certificate authority can be trusted.

In some embodiments, if a device's certificate is going to expire, the device can request a new certificate. If the device is an intermediate certificate authority 220 or an end entity 230, a new private key can be created along with a request for a certificate by creating and sending a PKCS #10 file (this can be referred to as a join process, where a PKCS #10 request and a private key are created). The first time a join process is performed, an administrator can manually enter a URL and/or password such that the device can connect to a remote certificate authority. In subsequent processes, however, the device can connect to a remote certificate authority (which can be determined using a URL in an AIA id-cmc and a private key from an existing certificate) and log in using the existing private key to request a new certificate. Note, that descriptions of an AIA id-cmc can be found in RFC 5272, and in RFC 7030. After the device logs into a remote certificate authority, a PKCS #7 file can be retrieved containing an identity certificate (wherein a public key matches the private key), and a certificate chain can be created validating PKIX to the current root certificate authority 210. The device can then connect to a remote certificate authority (e.g., third party certificate authority 240) and login.

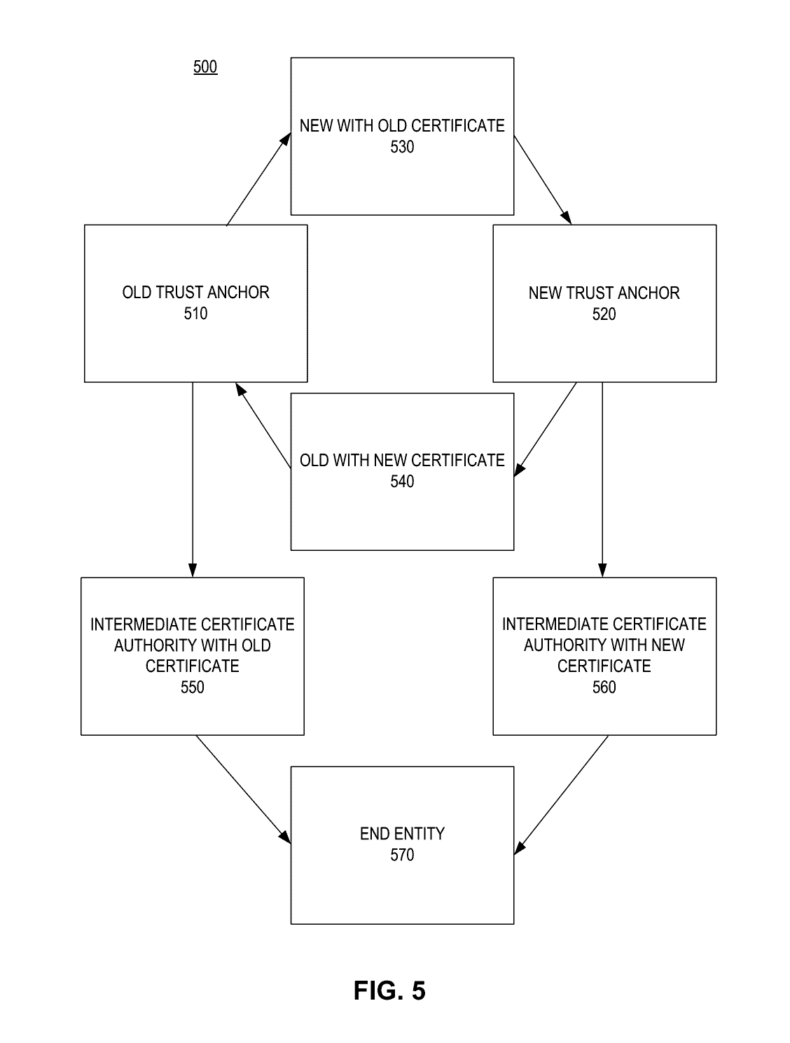

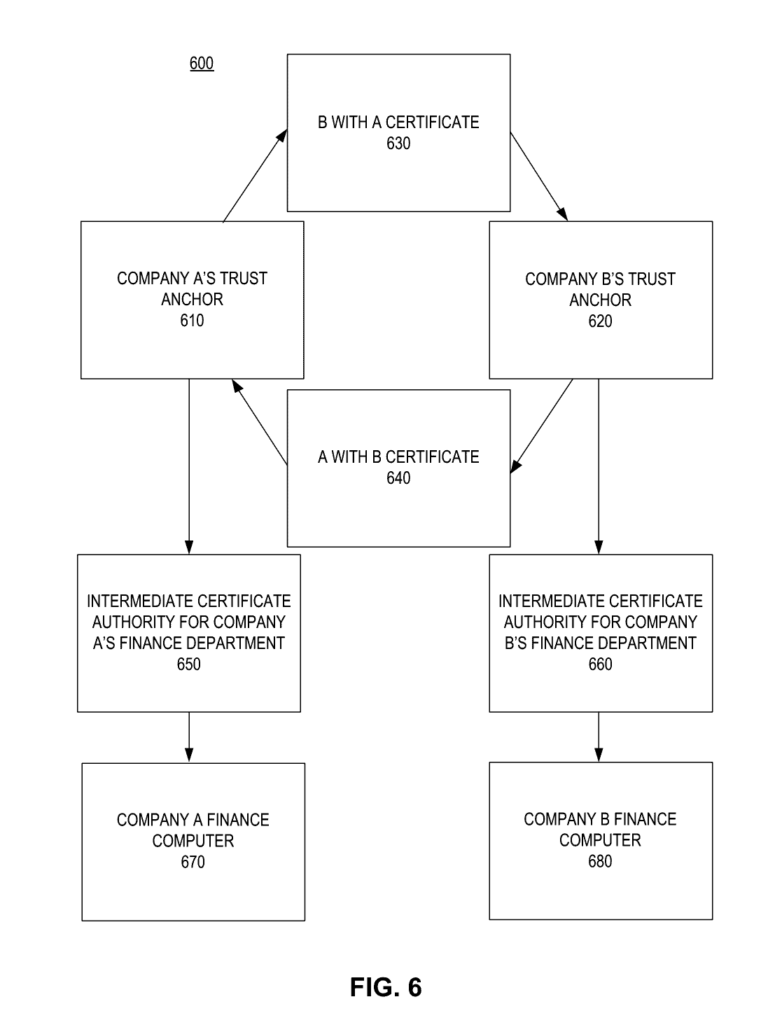

As will be described in greater detail below, if root certificate authority's 210 certificate is going to expire, the root certificate can be updated (as will be described below with reference to FIG. 5 and FIG. 6). In the case where no cross-signing is required, root certificate authority 210 can generate certificates including: (1) the old root certificate signed by the old root certificate (also known as an old-with-old certificate, or the existing root certificate); (2) a new root certificate signed by an old root certificate (also known as a new-with-old certificate); (3) an old root certificate signed by a new root certificate (also known as an old-with-new certificate); and (4) a new root certificate (also known as a new-with-new certificate, or the new root certificate). This approach—updating a root certificate without cross-signing certificates—is described in Section 4.4.1 of RFC 4210.

It should be noted that in embodiments described herein, a root certificate authority can be referred to as a trust anchor. Also, in the various embodiments described herein, intermediate certificate authority 220 can refer to a certificate authority in between root certificate authority 210 and end entity 230 (e.g., intermediate certificate authority 220 is a certificate authority that can (1) be trusted because the root certificate authority can be trusted, and (2) cause an end entity to be trusted because it can be trusted). Intermediate certificate authority 220 does not need to be directly connected to root certificate authority 210 or end entity 230, and can have additional intermediate certificate authorities between itself and root certificate authority 210 and/or end entity 230. A certificate path between root certificate authority 210 and end entity 230 can include multiple intermediate certificate authorities 220 in between (e.g., three, four, five, etc.). A certificate path can be referred to herein as a chain, certificate chain, chain of certificates, or server chain. Also, while in some embodiments certificates can be pushed to devices, it should be appreciated that certificates can be pulled by devices, and thus the terms push and pull can be used to describe the receiving or sending data such as a certificate, regardless of which term is used.

A third party certificate authority 240 can also be referred to as a central certificate authority. Third party certificate authority 240 can (or may need to) update one or more devices, such as root certificate authority 210, intermediate certificate authority 220, or an end entity 230. Embodiments described herein can accomplish this using Subject Information Access Extensions, such as the id-ad-caRepository extension defined in RFC 5280. A subject information access extension indicates how to access information and services at the device identified by a certificate. When the device is a certificate authority, such information and services can include certificate validation services and certificate authority policy data. When the device is an end entity, the information can include the type of services offered by the end entity and how to access them.

In examples described herein, for a device to request a certificate over HTTPS, the device retrieves a PKCS #7 file (e.g., a file that contains certificates from a certificate authority's repository). RFC 2315 defines the structure of a PKCS #7 file. A PKCS #7 file is produced by a certificate authority containing certificates that the certificate authority issues. Certificates in a PKCS #7 file can include multiple extensions known as ExtendedCertificates that help to identify chains. The PKCS #7 file can also contain a root certificate. If the root certificate does not validate the certificates used in the HTTPS connection, then third party certificate authority 240 can be determined to be untrusted.

Although all certificates issued by a certificate authority can be present in a single PKCS #7 file, they do not need to be. In at least some embodiments described herein, a PKCS #7 file can include fewer certificates and additional certificates (from a certificate repository) that can assist in building chains. The certificates returned in a PKCS #7 file can be based at least in part on the identity of a device that authenticates itself to a certificate authority. By receiving fewer than all of the certificates from a certificate repository, various devices can determine gaps in a server chain and fill them in based at least in part on the certificates the device does receive.

In various embodiments, end entities 230 and other devices can periodically (e.g., once a day, week, etc.) poll for third party certificate authority 240 (also known as a caRepository endpoint) for replacement (or updated) certificates. If end entity 230 determines that a replacement certificate is needed, it can attempt to retrieve a PKCS #7 file from third party certificate authority 240 over HTTPS, for building a server chain. When building such a server chain, end entity 230 can send a PKCS #10 file to a certificate authority to request a PKCS #7 file. This is sometimes referred to as a PKCS #10 Certificate Request. PKCS #10 Certificate Requests can include various requests when submitted to a certificate authority. For instance, a PKCS #10 file can include requests for certificates with one or more particular extensions (e.g., a Subject Key Identifier Extension, which is an identifier that aids a certificate chaining system in matching public keys to signatures). In some embodiments, end entity 230 can retrieve one new certificate issued by third party certificate authority 240. This new certificate is the latest version of a certificate that identifies end entity 230. The new certificate can have the same public key as the previous certificate, along with a later ValidFrom date (e.g., a time and/or date indicating when a certificate's validity period starts). Based on a ValidFrom date, certificates with the same public key can be differentiated.

If end entity 230 receives a new certificate, it can determine whether it can build a valid chain to itself from root certificate authority 210 using the new certificate and a PKIX chain validation algorithm. If it is determined that end entity 230 can build this chain, then end entity 230 can safely begin using the new certificate it received from third party certificate authority 240. If there is a new root certificate, then a device (e.g., intermediate certificate authority 220, end entity 230, etc.) can verify whether the new root certificate can be trusted based on a root certificate update algorithm. This approach can guarantee the continuity of trust as root certificates are updated.

In various embodiments, intermediate certificate authorities 220 can be identified and/or authenticated based at least in part on their ValidFrom dates, since they can have the same ValidFrom date as another certificate in a chain (e.g., acquired using an extension). If an intermediate certificate authority (or other device) has a choice regarding which certificate to use to authenticate itself with (e.g., when more than one certificate is within its validity period), the certificate with the most recent ValidFrom data is typically used. In some embodiments, intermediate certificate authorities 220 can be untrusted, and there might not be a requirement to cryptographically validate them further. As such, embodiments described herein allow intermediate certificate authorities 220 to be untrusted and stored (e.g., as part of a certificate chain) for later use. Intermediate certificate authorities 220 can become trusted if an end entity 230 determines that they can be trusted, as described above, or if they receive a certificate from third party certificate authority 240—in the same way as described above with respect to updating end entities' certificates.

In some embodiments, a trust anchor may need to be replaced. To replace a certificate that identifies root certificate authority 210 (e.g., a trust anchor), root certificate authority 210 can send a PKCS #10 file to request three certificates from third party certificate authority 240. Third party certificate authority 240 can issue a PKCS #7 file with three certificates (e.g., using a standard extension): (1) a new certificate (which can be self-signed and has a more recent ValidFrom date and a new public key); (2) a new-with-old certificate; and (3) an old-with-new certificate. New-with-old and old-with-new are certificates that can be used to update a trust anchor. An old-with-new certificate can have a validity period starting at the generation time of the old (e.g., previous) key pair and ending at the expiry time of the old public key. A new-with-old certificate can have a validity period starting at the generation time of the new key pair and ending at the time by which all end entities of the trust anchor authority will securely possess the new trust anchor's public key (e.g., at the latest, by the expiry date of the old public key). For security, an X.509 Subject Name is the same in all certificates and matches the trust anchor that is replaced. For example, an X.509 Subject Name can comprise a domain component, such as DC=citrix.com.

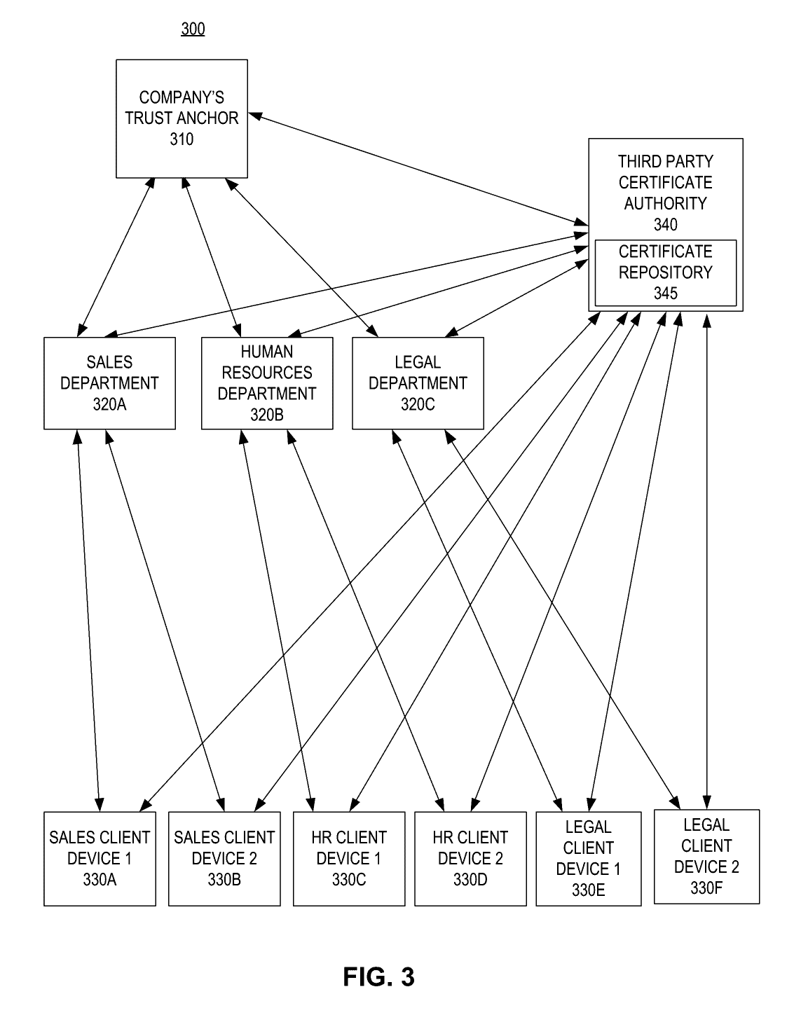

FIG. 3 also illustrates a block diagram of an exemplary PKI network environment 300, consistent with embodiments of the present disclosure. Environment 300, however, provides real-life examples. For instance, a company can have its own trust anchor/root certificate authority 310, different intermediate certificate authorities for various departments (or sub-departments, which are not shown), such as a sales department certificate authority 320A, a human resources department certificate authority 320B, and a legal department certificate authority 320C (collectively 320). Further, each end entity (or client device) can authenticate itself to a corresponding department's certificate authority. For example, sales client device 1 330A and sales client device 2 330B can authenticate themselves to a sales department certificate authority 320A. Similarly, Human Resources client device 1 330C and Human Resources client device 2 330D can authenticate themselves to the human resources department certificate authority 320B. Also, legal department client device 1 330E and legal department client device 2 330F can authenticate themselves to legal department certificate authority 320C.

As with environment 200, environment 300 also illustrates an example third party certificate authority 340 that includes a certificate repository 345. Third party certificate authority 340 can provide a trusted certificate authority or end entity with certificates (and public keys). It should be appreciated that a third party certificate authority 340 might not include a certificate repository 345. In particular, it should be noted that although all certificate authorities maintain a repository (list of certificates that the certificate authority has issued), the repository does not have to be on the same system as the signing key, and can be pushed to an external file share. In some embodiments, the SIA ca-caRepository on a certificate can point to an appropriate file share location.

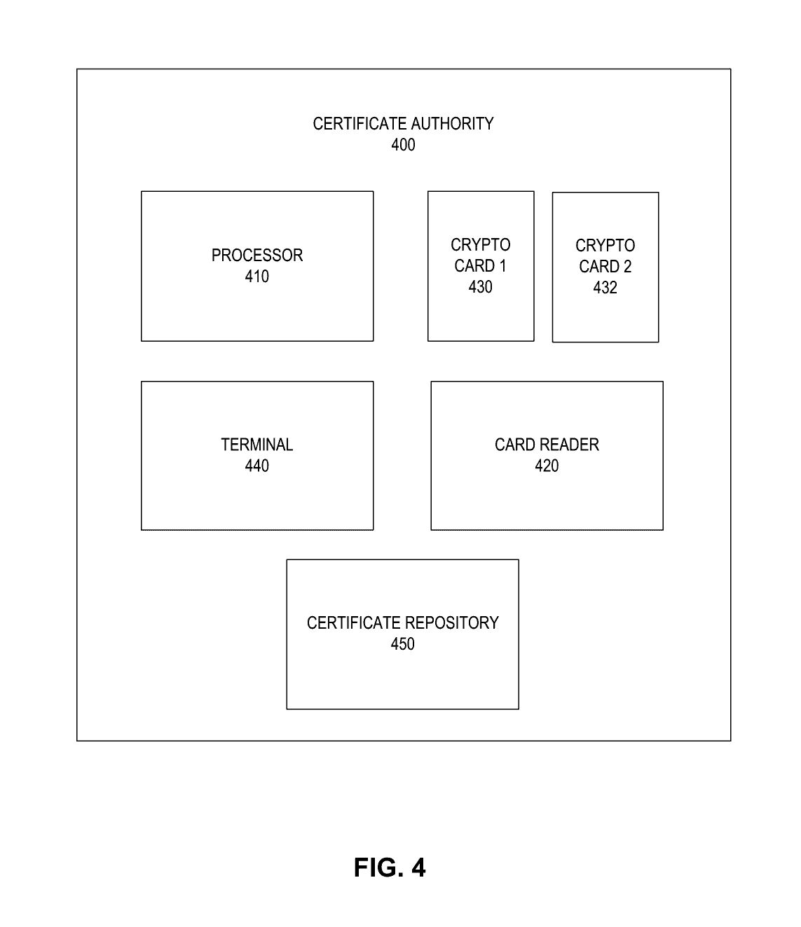

FIG. 4 illustrates a block diagram of an exemplary certificate authority 400, which can be a third party certificate authority (e.g., 240), a root certificate authority (e.g., 210), and/or an intermediate certificate authority (e.g., 220), consistent with embodiments of the present disclosure. While certificate authority 400 is illustrated as hardware, it is also appreciated that certificate authority 400 could be implemented as software on a computer device. Example certificate authority 400 is intended to illustrate potential components within a certificate authority, and there could be additional, or fewer components in certificate authority 400 as described in the embodiments herein. Exemplary certificate authority 400 can be a high security stand-alone system that generates its own keys for encryption/decryption, signs certificates of other certificate authorities, and generates and maintains certificate revocation lists (CRLs). Certificate authority 400 can also include a certificate repository 450, which can be used to generate PKCS #7 files.

A certificate authority 400 can include a processor 410 with at least one card reader 420. A card reader 420 can receive data from crypto card 1 430, and transmit data to certified crypto card 2 432. In some embodiments, certificate authority 400 includes a terminal 440 that includes a display and a keyboard, by which a human operator can enter registration, revocation and request information into the certificate authority 400.

In some embodiments, certificate authority 400 creates its own public/private key pair and signs a certificate using function calls to crypto card 1 430. In various embodiments, a completed certified crypto card 2 432 can be physically unplugged and physically delivered to a third party certificate authority (e.g., 240 or 340), or other trusted networked device. Other security methods as known in the art can be used to ensure the security of a third party certificate authority.

FIG. 5 illustrates a block diagram of an exemplary PKI environment 500, consistent with embodiments of the present disclosure. Environment 500 illustrates an example approach for replacing a trust anchor 510. Environment 500 includes an old trust anchor 510, a new trust anchor 520, a new-with-old certificate 530, an old-with-new certificate 540, an intermediate certificate authority with an old certificate 550, an intermediate certificate authority with a new certificate 560, and an end entity 570.

As described above, trust anchors change periodically. As shown in FIG. 5, the trust anchor changes from old trust anchor 510 to new trust anchor 520. An end entity 570 can use either old trust anchor 510 (via intermediate certificate authority with an old certificate 550) or new trust anchor 520 (via intermediate certificate authority with a new certificate 560) if the chain contains a requisite amount of certificates.

In some embodiments, where no cross-signing is necessary, a root certificate can be used to authenticate an intermediate certificate authority, and the intermediate certificate authority can be used to authenticate an end entity. Here, using the root certificate update algorithm as described in Section 4.4.1 of RFC 4210, a root certificate authority first generates a new key pair. Thereafter, a certificate containing the old public key signed with the new private key is created by the root certificate authority. This is referred to as the old-with-new certificate 540. After this step, a certificate containing a new public key for the root certificate authority is signed with the old private key. This is referred to as the new-with-old certificate 530. Lastly, a certificate containing the new public key for the root certificate authority is created and signed with the new private key. This is referred to as a new-with-new certificate. These new certificates are then published via a certificate repository and/or other means. The new certificate authority public key is exported such that devices (e.g., intermediate certificate authority with new certificate 560 and end entity 570) can acquire it. The root certificate authority's old private key (e.g., old trust anchor 510) is no longer needed. However, it can remain for some time, for instance until all end entities 570 or other devices have securely acquired the certificate authority's new public key.

FIG. 6 is a block diagram of an exemplary PM environment 600 that illustrates an example approach for cross-signing a trust anchor. PM environment 600 comprises a Company A's trust anchor 610, Company B's trust anchor 620, B with A certificate 630, and A with B certificate 640. PKI environment 600 further comprises an intermediate certificate authority for Company A's finance department 650, an intermediate certificate authority for company B's finance department 660, a finance computer belonging to Company A 670, and a finance computer belonging to company B 680.

For these two companies to successfully merge, Company A's trust anchor 610 (e.g., its root certificate authority) should trust intermediate certificate authority for Company B 660 and one or more finance computers belonging to Company B 680. Similarly, Company B's trust anchor 620 (e.g., its root certificate authority) should be able to trust intermediate certificate authority for Company A 650 and one or more finance computers belonging to Company A 670.

To do this, Company A signs Company B's trust anchor, referred to as B with A certificate 630. Company B, likewise, signs Company A's trust anchor, referred to as A with B certificate 640. By including these certificates in a PKCS #7 file, company A and Company B can trust each other's computers (e.g., computer 670 and computer 680). This process can be repeated when a root certificate update occurs, as A with B certificate 640 and B with A certificate 630 will eventually expire. It should be appreciated that an X.509 subject name/issuer is not the same when cross-signing is implemented. Further, the validity periods of B with A certificate and A with B certificate can be different than New with Old and Old with New certificates.

Further, although not shown in PKI environment 600, eventually the certificate authorities used by Company A and Company B may decide to merge into one. In such a case, the certificates are signed at the root level, and Company A can sign and push out intermediate certificates for Company B. Certificate B with A 630 and Certificate A with B 640 can lapse, and then one certificate authority can remain valid, such as Company A's trust anchor.

FIG. 7 is a flowchart representing an exemplary method 700 of building a chain (e.g., validating another device's certificate when connecting to a TLS server), consistent with embodiments of the present disclosure. Referring to FIG. 7, it will readily be appreciated that the illustrated procedure can be altered to delete steps or further include additional steps, as described below. Moreover, steps can be performed in a different order than shown in method 700, and/or in parallel. While the flowchart representing method 700 provides exemplary steps for a device (e.g., a device associated with one or more root certificate authorities, one or more trust anchors, etc.) to authenticate devices and transmit data, it is appreciated that one or more other devices may perform substantially similar steps alone or in combination with the root certificate authority/trust anchor.

After initial start step 710, a determination is made whether a PKIX algorithm will work with an acquired chain (e.g., a certificate chain, server chain, etc. as described above). If the PKIX algorithm works with the chain as sent, the method ends at step 760. If, however, the PKIX algorithm does not work with the chain as sent, at step 730 the AIA id-caIssuers extension is acquired from the certificate including the chain, which includes a URL pointing at the certificate authority that issued the certificate. After the algorithm knows the URL of the certificate authority that issued the certificate, at step 740 a device acquires a PKCS #7 file from the URL acquired from the certificate. No authentication is required for this step, since the certificate contains authentication information associated with the current intermediate certificate authorities, the root certificate authority, and the root update certificates. After, at step 750, a chain is built using the certificates acquired from the URL, and the PKIX algorithm is executed again to build a chain. After the chain is built, the method 700 ends at step 760.

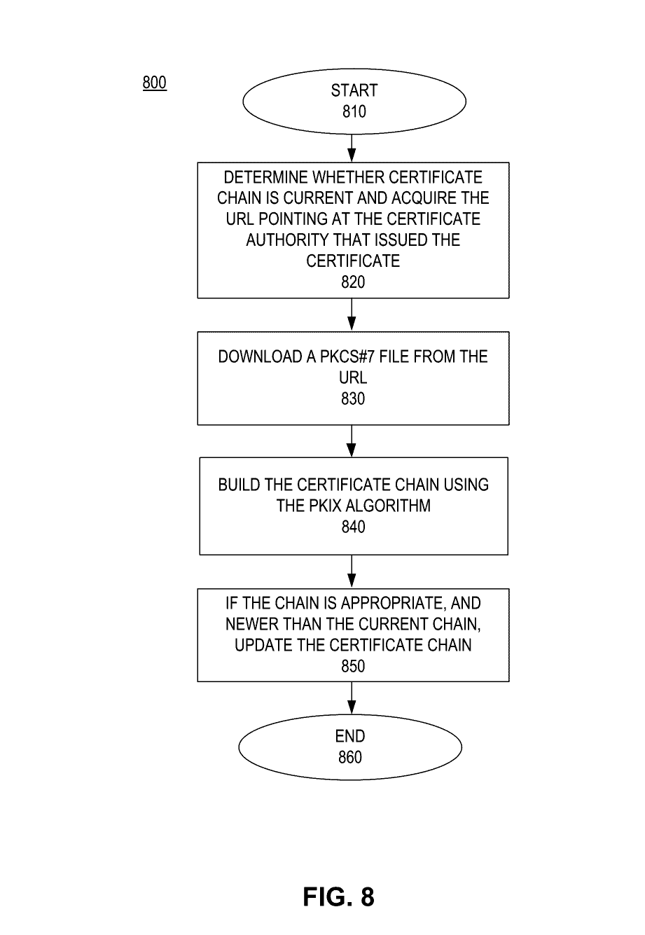

FIG. 8 is a flowchart representing an exemplary method 800 representing a certificate-chain maintenance evaluation, consistent with embodiments of the present disclosure. Referring to FIG. 8, it will readily be appreciated that the illustrated procedure can be altered to delete steps or further include additional steps, as described below. Moreover, steps can be performed in a different order than shown in method 800, and/or in parallel. While the flowchart representing method 800 provides exemplary steps for a device (e.g., a device associated with one or more root certificate authorities, one or more trust anchors, etc.) to authenticate devices and transmit data, it is appreciated that one or more other devices may perform substantially similar steps alone or in combination with the root certificate authority/trust anchor. Moreover, it is appreciated the method 800 can be performed at set times and/or periodically.

After initial start step 810, to perform maintenance, at step 820 a device can determine whether it has the latest version of its certificate and/or that it can build a chain back to a root certificate authority (e.g., it determines whether it should pull from the certificate authority repository). A device can poll (e.g., call back) to its certificate authority at a particular frequency, such as once a day, to see if there is a new certificate chain available. As discussed herein, a device can acquire a URL from its certificate that directs the device to a certificate authority (e.g., the certificate authority that issued the certificate to the device). This URL is included in the SIA id-caRepository extension of the certificate. The method 800 continues to step 830 where the device connects to the URL and downloads a PKCS #7 file. This file can be authenticated with the device's existing private key. This PKCS #7 file can contain a new certificate and chain (e.g., it is the correct version of the certificate that the device should be using). Further, the downloaded PKCS #7 file can include a public key that corresponds to an existing private key. In some embodiments, the Subject Name on the downloaded certificate can match the Subject Name on the existing device's existing certificate. Thereafter, at step 840, a certificate chain is built using the PKIX algorithm (e.g., a chain from a locally trusted root certificate authority to a device's matching private key). At step 850, if the chain is appropriate (e.g., based on the same trust anchor) and it has a more recent ValidFrom date than the certificate the device has been using, the downloaded new certificate can be used. The method 800 then ends at step 860.

In various other embodiments, some of the features described herein can be simulated by providing a device with direct access to a certificate authority via CMC (Certificate Management over Cryptographic Message Syntax Standard). CMC may not include provisions to update a trust anchor via certificates, however, or be able to operate correctly during a period where different clients and servers are using different versions of certificates. Similarly, Microsoft™ Windows™ can provide a system similar to the CMC protocol described above for machines using an Active Directory domain. This can have similar restrictions, however, and can additionally require devices requesting certificates to be using a proprietary Active Directory domain. It is also possible to manually install certificates. Such an embodiment is feasible if the certificates have long validity dates. In some embodiments, security policies might mandate that end entity certificates are replaced once a week, month, year, etc.

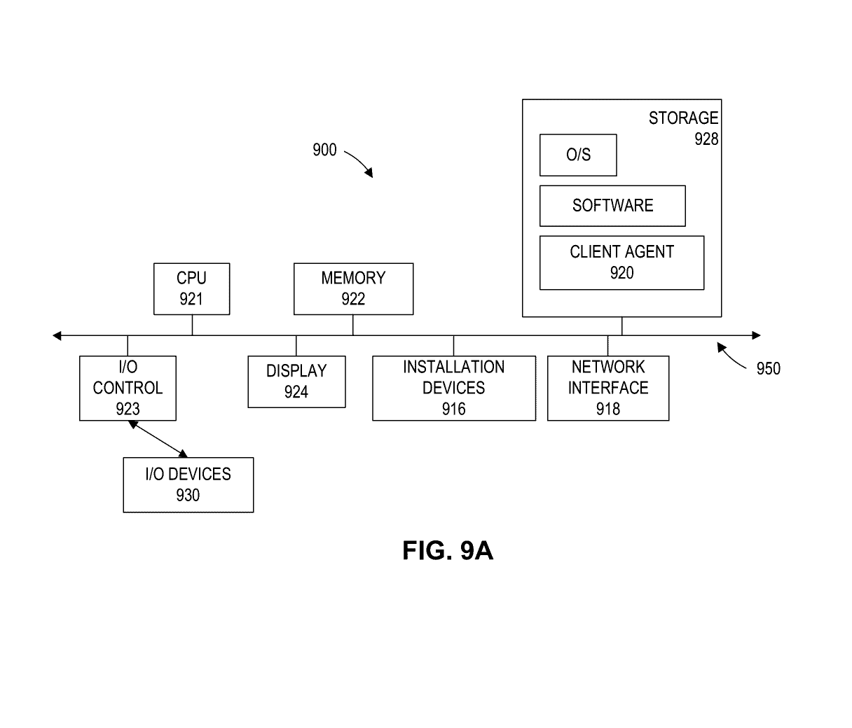

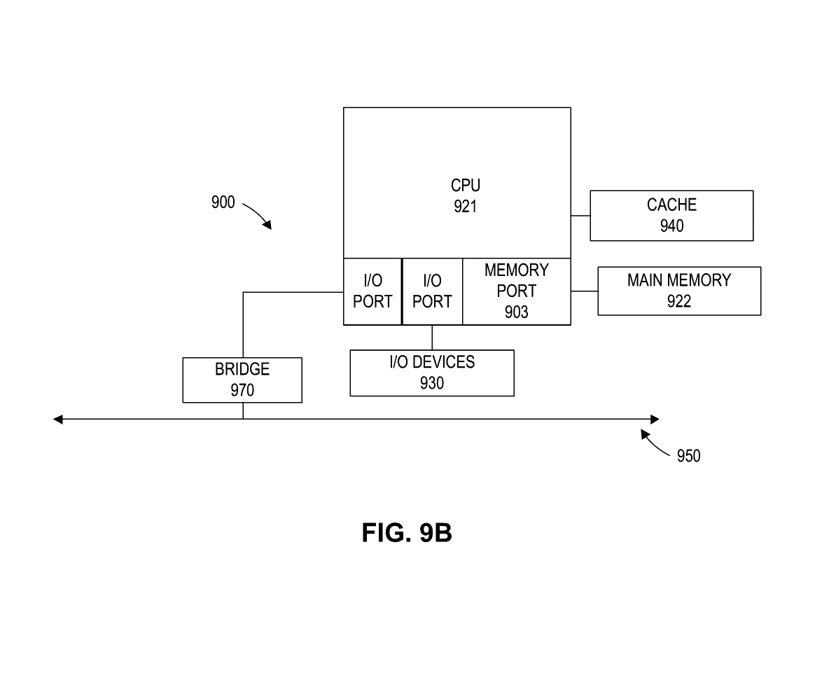

As shown in FIGS. 9A-9B, each computing device 900 (e.g., an end entity and devices associated with and/or including a root certificate authority or an intermediary certificate authority) includes a central processing unit (CPU) 921 and a main memory 922. CPU 921 can be any logic circuitry that responds to and processes instructions fetched from the main memory 922. CPU 921 can be a single or multiple microprocessors, field-programmable gate arrays (FPGAs), or digital signal processors (DSPs) capable of executing particular sets of instructions stored in a memory (e.g., main memory 922) or cache (e.g., cache 940). The memory can include a tangible and/or nontransitory computer-readable medium, such as a flexible disk, a hard disk, a CD-ROM (compact disk read-only memory), MO (magneto-optical) drive, a DVD-ROM (digital versatile disk read-only memory), a DVD-RAM (digital versatile disk random-access memory), flash memory, a RAM, a cache, a register, or a semiconductor memory. Main memory 922 can be one or more memory chips capable of storing data and allowing any storage location to be accessed by CPU 921. Main memory 922 can be any type of random access memory (RAM), or any other available memory chip capable of operating as described herein. In the exemplary embodiment shown in FIG. 9A, CPU 921 communicates with main memory 922 via a system bus 950. Computing device 900 can also include a visual display device 924 and an input/output (I/O) device 930 (e.g., a keyboard, mouse, or pointing device) connected through I/O controller 923, both of which communicate via system bus 950. Furthermore, I/O device 930 can also provide storage and/or an installation medium for the computing device 900.

FIG. 9B depicts an embodiment of an exemplary computing device 900 in which CPU 921 communicates directly with main memory 922 via a memory port 903. CPU 921 can communicate with a cache 940 via a secondary bus, sometimes referred to as a backside bus. In some other embodiments, CPU 921 can communicate with cache 940 via system bus 950. Cache 940 typically has a faster response time than main memory 922. In some embodiments, CPU 921 can communicate directly with I/O device 930 via an I/O port. In further embodiments, I/O device 930 can be a bridge 970 between system bus 950 and an external communication bus, such as a USB bus, an Apple Desktop Bus, an RS-232 serial connection, a SCSI bus, a FireWire bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

As shown in FIG. 9A, computing device 900 can support any suitable installation device 916, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive; or any other device suitable for installing software and programs such as any client agent 920, or portion thereof. Computing device 900 can further comprise a storage device 928, such as one or more hard disk drives or redundant arrays of independent disks, for storing an operating system and other related software, and for storing application software programs such as any program related to client agent 920. Optionally, any of the installation devices 916 could also be used as storage device 928.

Furthermore, computing device 900 can include a network interface 918 to interface to a LAN, WAN, MAN, or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. Network interface 918 can comprise a built-in network adapter, network interface card, PCMCIA network card, card bus network adapter, wireless network adapter, USB network adapter, modem or any other device suitable for interfacing computing device 900 to any type of network capable of communication and performing the operations described herein.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A computing device comprising:
a memory storing a set of instructions; and
a processor configured to execute the set of instructions to cause the computing device to perform:
communicate with a certificate authority, wherein the communication provides information regarding whether a first certificate stored on the computing device is valid;
if the first certificate is no longer valid, acquire a second certificate from the certificate authority, wherein the second certificate includes one or more certificate extensions; and
build a chain of certificates to a root certificate authority using the second certificate.

2. The appliance of claim 1, wherein the communication with the certificate authority includes at least one PKCS #7 file.

3. The appliance of claim 2, wherein the second certificate includes a portion of a total amount of certificates associated with the certificate authority's certificate repository.

4. The appliance of claim 2, wherein the second certificate is included in a PKCS #7 file.

5. The appliance of claim 1, wherein the chain of certificates is built using a PKIX chain validation algorithm.

6. The appliance of claim 1, wherein the communication with the certificate authority includes the first certificate and a ValidFrom time.

7. The appliance of claim 6, wherein the first certificate is determined to not be valid using the ValidFrom time.

8. A method for determining valid intermediate certificate authorities, the method being performed by one or more processors and comprising:
communicating with a certificate authority, wherein the communication provides information regarding whether a first certificate stored on the computing device is valid;
if the first certificate is no longer valid, acquiring a second certificate from the certificate authority, wherein the second certificate includes one or more certificate extensions; and
building a chain of certificates to a root certificate authority using the second certificate.

9. The method of claim 8, wherein the communication with the certificate authority includes at least one PKCS #7 file.

10. The method of claim 9, wherein the second certificate including includes a portion of a total amount of certificates associated with the certificate authority's certificate repository.

11. The method of claim 9, wherein the second certificate is included in a PKCS #7 file.

12. The method of claim 8, wherein the chain of certificates is built using a PKIX chain validation algorithm.

13. The method of claim 8, wherein the communication with the certificate authority includes the first certificate and a ValidFrom time.

14. The method of claim 13, wherein the first certificate is determined not to be valid using the ValidFrom time.

15. A nontransitory computer readable storage medium storing a set of instructions that are executable by at least one processor of a computer, to cause the computer to perform a method for determining valid intermediate certificate authorities, the method comprising:
communicating with a certificate authority, wherein the communication provides information regarding whether a first certificate stored on the computing device is valid;
if the first certificate is no longer valid, acquiring a second certificate from the certificate authority, wherein the second certificate includes one or more certificate extensions; and
building a chain of certificates to a root certificate authority using the second certificate.

16. The nontransitory computer readable storage medium of claim 15, wherein the communication with the certificate authority includes at least one PKCS #7 file.

17. The nontransitory computer readable storage medium of claim 16, wherein the second certificate including includes a portion of a total amount of certificates associated with the certificate authority's certificate repository.

18. The nontransitory computer readable storage medium of claim 16, wherein the second certificate is included in a PKCS #7 file.

19. The nontransitory computer readable storage medium of claim 15, wherein the communication with the certificate authority includes the first certificate and a ValidFrom time.

20. The nontransitory computer readable storage medium of claim 19, wherein the first certificate is determined not to be valid using the ValidFrom time.
